(19) United States
(12) Patent Application Publication
(10) Pub. No.: US 2016/0275359 A1
(43) Pub. Date: Sep. 22, 2016

(54) INFORMATION PROCESSING APPARATUS, INFORMATION PROCESSING METHOD, AND COMPUTER READABLE MEDIUM STORING A PROGRAM

(71) Applicant: MITSUBISHI ELECTRIC CORPORATION, Chiyoda-ku, Tokyo (JP)

(72) Inventors: Michinori YOSHIDA, Tokyo (JP); Masahiro ABUKAWA, Tokyo (JP); Shu MURAYAMA, Tokyo (JP); Jumpei HATO, Tokyo (JP)

(73) Assignee: MITSUBISHI ELECTRIC CORPORATION, Tokyo (JP)

(21) Appl. No.: 15/035,023

(22) PCT Filed: Sep. 30, 2014
(86) PCT No.: PCT/JP2014/076011

§ 371 Date: May 6, 2016

(30) Foreign Application Priority Data
Dec. 26, 2013 (JP) 2013-268350

(51) Int. Cl. G06K 9/00; H04N 5/232; G01B 11/02; G06T 7/00; G01S 17/08; G01S 17/93

(52) U.S. Cl. CPC G06K 9/00805; G01S 17/08; G01S 17/936; G01B 11/02; G06T 7/0051; H04N 5/232; G06T 2207/30252

(57) ABSTRACT

An image extraction unit (104) extracts an image of a specific photographic object from among images of photographic objects included in a photographic image photographed by a camera (200). A distance calculation processing execution unit (105) executes a distance calculation processing in which a distance from the camera (200) to a photographic object is calculated using an image of the photographic object included in the photographic image, exclusively to the image of the specific photographic object extracted by the image extraction unit (104).

### TECHNICAL FIELD

The present invention relates to a technology for analyzing a photographic image photographed by a camera.

### BACKGROUND ART

Research and development of on-vehicle equipment utilizing a HUD (Head Up Display) technology that displays information overlaid on scenery on a semi-transparent display is being carried out actively.

Further, research and development of a technology for avoiding a vehicle collision and reducing an impact is being carried out actively.

These pieces of technology aim to notify a vehicle occupant of a surrounding situation of a vehicle or to control the vehicle by grasping the surrounding situation of the vehicle.

In these pieces of technology, it is necessary that surroundings of the vehicle are three-dimensionally grasped and managed by utilizing a sensor and a camera.

When grasping surroundings of the vehicle, three-dimensional information is often expressed by utilizing a solid model, a surface model, or a large number of points (dots).

In the solid model, the surface model, and the like, an information amount of the three-dimensional information is increased.

As a way to reduce the information amount, it is considered to utilize a method with less information amount such as a wire frame model or the like rather than the solid model or the surface model.

In Patent Literature 1, a wire frame model is used.

Patent Literature 1 discloses a three-dimensional image generation system that automates a feature point setting processing and a patch setting processing of a photographic image and enables generation of a three-dimensional image of high picture quality.

In this system, target object characteristics are detected, and a three-dimensional model generation area is automatically extracted based upon a shape model stored in a database.

Further, a feature point is automatically set according to feature point position setting data of a target object shape model stored in the database with respect to the extracted generation area.

Furthermore, a triangular patch by the model is automatically generated for the set feature point, and wire frame rendering matching an actual target object shape becomes possible, so that respective processes of a three-dimensional model generation processing can be automated in the technology of Patent Literature 1.

### CITATION LIST

### Patent Literature

Patent Literature 1: JP 2002-32742 A

### SUMMARY OF INVENTION

### Technical Problem

Conventionally, as a model to express a three-dimensional shape, a solid model or a surface model is used.

However, in on-vehicle equipment, it is necessary to reflect a situation which changes every moment to the model in real time.

There is a problem that a process of constructing a three-dimensional model by utilizing the solid model or the surface model as in conventional cases becomes heavy, so that a surrounding situation of a vehicle cannot be reflected to the three-dimensional model in real time.

Further, when utilizing a wire frame model such as Patent Literature 1, it is necessary to analyze a photographic image and calculate a distance between a surrounding object (a photographic object) of the vehicle and a camera before generating the wire frame model.

In conventional arts utilizing the wire frame model including Patent Literature 1, a distance calculation processing is performed for the entire photographic image.

Although the photographic image includes objects which are not generation targets of the wire frame model, the wire frame model cannot be generated until the distance calculation processing is completed for the entire photographic image.

Thus, it is required to increase the efficiency of the distance calculation processing in order to further improve the real-time property of the three-dimensional model construction.

The present invention has been conceived in view of these circumstances and mainly aims to increase the efficiency of the distance calculation processing in the three-dimensional model construction.

### Solution to Problem

An information processing apparatus according to the present invention includes:

an image extraction unit to extract an image of a specific photographic object from among images of photographic objects included in a photographic image photographed by a camera; and

a distance calculation processing execution unit to execute a distance calculation processing in which a distance from the camera to a photographic object is calculated using an image of the photographic object included in the photographic image, exclusively to the image of the specific photographic object extracted by the image extraction unit.

### Advantageous Effects of Invention

According to the present invention, the distance calculation processing is executed exclusively to the image of the specific photographic object. As a result, it is not necessary to wait for the completion of the distance calculation processing for other photographic objects, the distance calculation processing can be accelerated, and the construction of the three-dimensional model can be operated at high speed.

### BRIEF DESCRIPTION OF DRAWINGS

FIG. 1 is a diagram illustrating a configuration example of an information processing apparatus according to a first embodiment.

FIG. 2 is a diagram illustrating an arrangement example of a camera and a sensor according to the first embodiment.

FIG. 3 is a diagram illustrating a scanning example of the sensor according to the first embodiment.

FIG. 4 is a diagram illustrating an example of a photographic image of the camera according to the first embodiment.

FIG. 5 is a diagram illustrating an example of a ranging result of the sensor according to the first embodiment.

FIG. 6 is a flowchart diagram illustrating an operation example of the information processing apparatus according to the first embodiment.

FIG. 7 is a diagram illustrating a relation between the photographic image of the camera and the ranging result of the sensor according to the first embodiment.

FIG. 8 is a diagram illustrating an outline of an image recognition using a recognition range according to the first embodiment.

FIG. 9 is a diagram illustrating a method to operate the image recognition by expanding the recognition range gradually according to the first embodiment.

FIG. 10 is a diagram illustrating a method to operate the image recognition using the recognition range based upon an estimation size according to the first embodiment.

FIG. 11 is a flowchart diagram illustrating in detail a process for extracting an image of a target photographic object according to the first embodiment.

FIG. 12 is a diagram illustrating a calculation procedure of a width of the object according to the first embodiment.

FIG. 13 is a flowchart diagram illustrating in detail a process for calculating a distance to a closest point according to the first embodiment.

FIG. 14 is a diagram illustrating the closest point and a wire frame model according to the first embodiment.

FIG. 15 is a diagram illustrating an example of a three-dimensional model table according to the first embodiment.

FIG. 16 is a diagram illustrating a configuration example of the information processing apparatus according to a second embodiment.

FIG. 17 is a diagram illustrating an example of an ID list according to the second embodiment.

FIG. 18 is a diagram illustrating an example of the three-dimensional model table according to the first embodiment.

FIG. 19 is a diagram illustrating a hardware configuration example of the information processing apparatus according to the first and second embodiments.

### DESCRIPTION OF EMBODIMENTS

### Embodiment 1

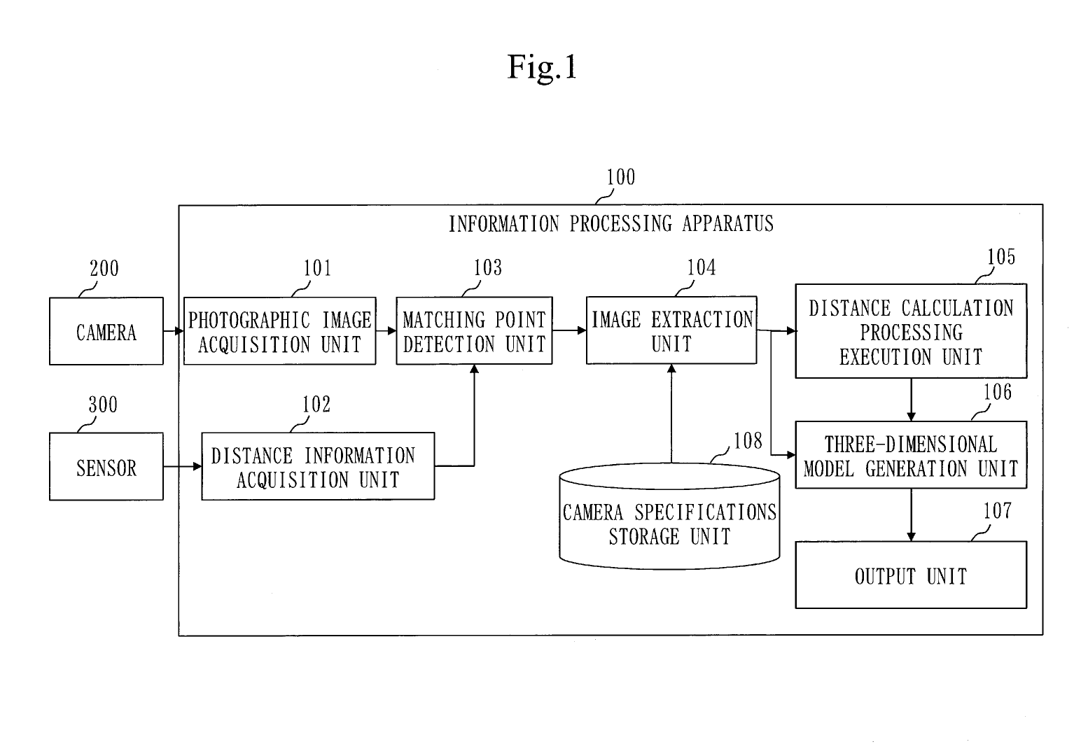

FIG. 1 illustrates a configuration example of an information processing apparatus 100 according to the present embodiment.

The information processing apparatus 100 according to the present embodiment is mounted on a vehicle (a mobile body).

The information processing apparatus 100 acquires a photographic image from a camera 200 mounted on the vehicle and acquires distance information from a sensor 300 also mounted on the vehicle.

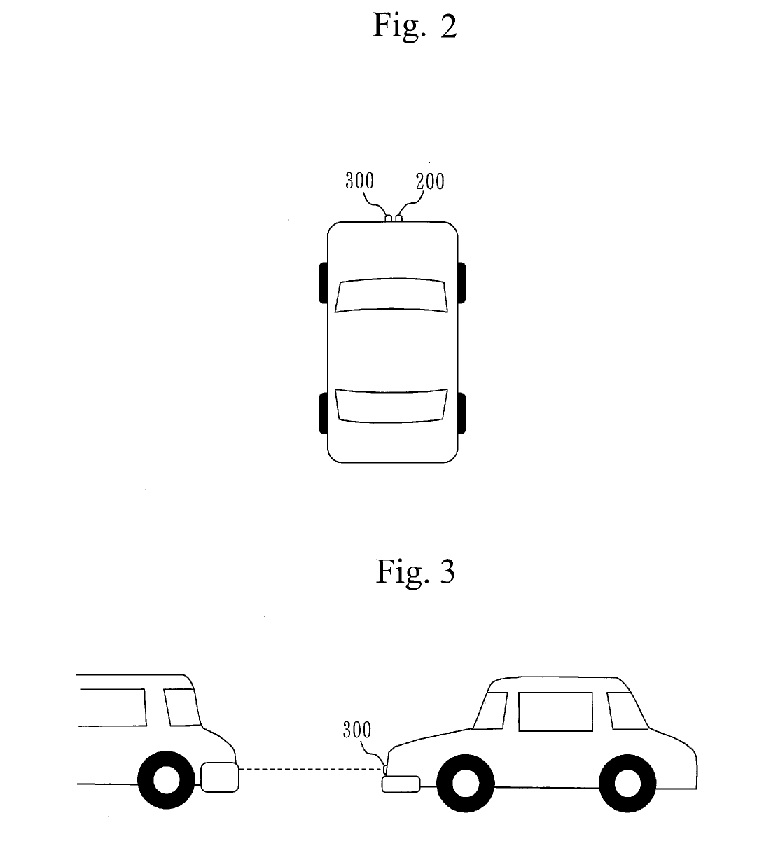

The camera 200 and the sensor 300 are, for example, as exemplified in FIG. 2, closely disposed on a front part of the vehicle.

The sensor 300 operates ranging, in parallel with photographing by the camera 200, in the photographing direction of the camera 200.

The sensor 300 is, for example, a LIDAR (Light Detection And Ranging).

The LIDAR measures, for example, as exemplified in FIG. 3, a distance to an object surrounding the vehicle by scanning a laser horizontally with about 0.4 degrees angular resolution over a wide range of 240 degrees.

Although the LIDAR acquires the distance only horizontally, other types of sensors (for example, a PMD (Photonic Mixer Device)) acquire a distance in the height direction as well.

When the distance in the height direction cannot be acquired like the LIDAR, information in the height direction can be acquired by creating a depthmap (a three-dimensional image) in the height direction using a stereo camera and a motion stereo technology by the camera 200.

Hereinafter, the description is continued under the assumption that the sensor 300 is the LIDAR.

In the information processing apparatus 100, a photographic image acquisition unit 101 acquires the photographic image photographed by the camera 200.

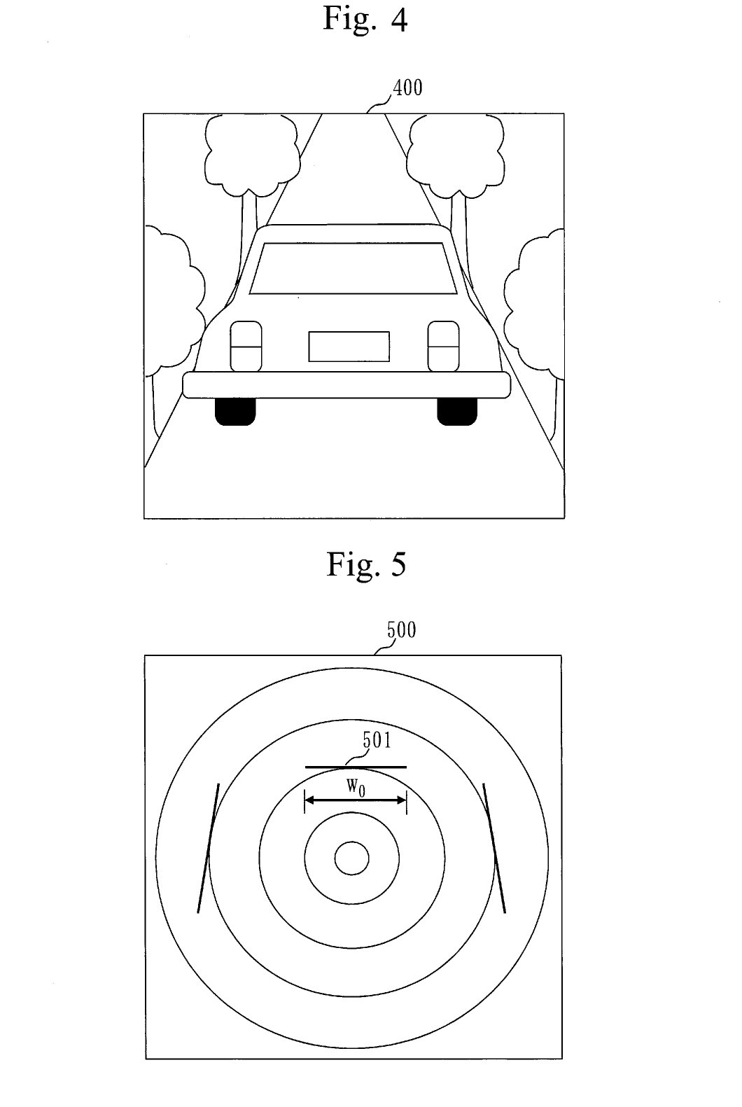

The photographic image acquisition unit 101 acquires, for example, a photographic image 400 of FIG. 4 in which a rear part of a front vehicle of FIG. 3 is photographed.

A distance information acquisition unit 102 acquires the distance information indicating the distance to the object acquired by the sensor 300.

The distance information acquisition unit 102 acquires, for example, a distance information 500 exemplified in FIG. 5.

A center of concentric circles of the distance information 500 corresponds to the position of the sensor 300, and each concentric circle represents a distance from the sensor 300.

The distance information 500 of FIG. 5 indicates a result, which is ranged in parallel with photographing the photographic image 400 of FIG. 4 by the camera 200, by the sensor 300.

That is, as illustrated in FIG. 3, the laser from the sensor 300 scans a bumper part of the front vehicle horizontally, and a line of a reference sign 501 in the distance information 500 of FIG. 5 represents a distance of the bumper part of the front vehicle in the photographic image 400 of FIG. 4.

Note that the distance information 500 of FIG. 5 schematically expresses the ranging result of the sensor 300 and does not express distances to all photographic objects in the photographic image 400.

A matching point detection unit 103 matches the photographic image acquired by the photographic image acquisition unit 101 and the distance information acquired by the distance information acquisition unit 102.

The camera 200 and the sensor 300 are calibrated beforehand so as to associate the object in the photographic image 400 with the measured distance.

As described above, the line of the reference sign 501 in the distance information 500 corresponds to the bumper part of the front vehicle in the photographic image 400, and the matching point detection unit 103 associates the line of the reference sign 501 with the bumper part of the front vehicle in the photographic image 400.

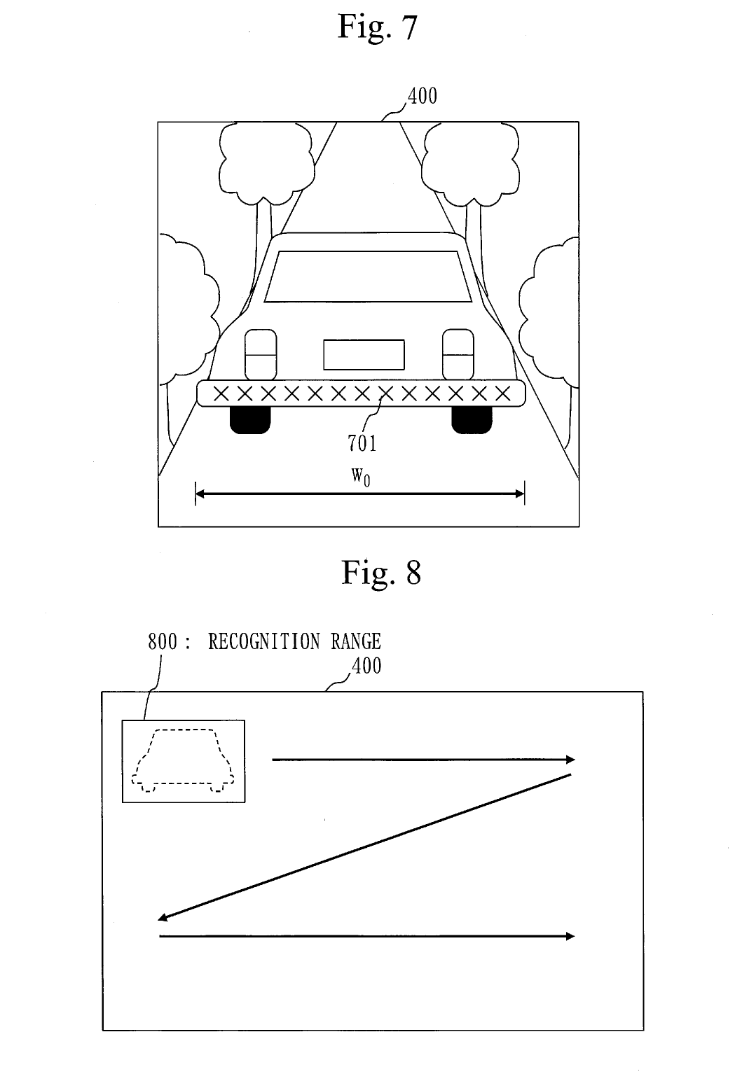

FIG. 7 illustrates a processing image of the matching point detection unit 103 and represents that the sensor 300 measures the distance to the bumper part of the front vehicle of the photographic image 400.

“xxxx” illustrated as a reference sign 701 of FIG. 7 represents that the bumper part of the front vehicle of the photographic image 400 is irradiated with the laser of the sensor 300.

Note that FIG. 7 is provided to make it easy to understand a process of the matching point detection unit 103, and the matching point detection unit 103 does not create an image such as FIG. 7.

Further, in FIG. 1, the matching point detection unit 103 acquires the photographic image via the photographic image acquisition unit 101 and acquires the distance information via the distance information acquisition unit 102.

When the matching point detection unit 103 has an interface with the camera 200 or the matching point detection unit 103 has an interface with the sensor 300, the matching point detection unit 103 may acquire the photographic image from the camera 200 directly or acquire the distance information from the sensor 300 directly.

An image extraction unit 104 extracts an image of a specific photographic object (a photographic object of a creation target for a wire frame, hereinafter referred to as the target photographic object) from among images of photographic objects included in the photographic image.

In the photographic image 400, trees are included in addition to the front vehicle as the photographic objects. However, because the front vehicle is the creation target for the wire frame, the image extraction unit 104 extracts the image of the front vehicle from among the images of photographic objects included in the photographic image 400.

When the image extraction unit 104 extracts the image of the target photographic object, camera specifications stored in a camera specifications storage unit 108 are referred to.

In the camera specifications storage unit 108, specifications (a focal length, an F value, a resolution, and the like) of the camera 200 are stored.

A distance calculation processing execution unit 105 calculates a distance to a closest point within the target photographic object.

The closest point is a point which is closest to the camera 200 within the target photographic object.

The distance calculation processing execution unit 105 executes a distance calculation processing in which the distance from the camera 200 to the photographic object is calculated, exclusively to the image of the target photographic object extracted by the image extraction unit 104.

In an example of FIG. 4, the image of the front vehicle is extracted from the photographic image 400 by the image extraction unit 104, and the distance calculation processing execution unit 105 executes the distance calculation processing exclusively to the image of the front vehicle.

The distance calculation processing is, for example, a depthmap processing.

Conventionally, the depthmap processing is operated to the entire photographic image 400, and the distance to the closest point is derived.

That is, conventionally, the distance to the closest point is derived through the depthmap processing. In the depthmap processing, the photographic image 400 is scanned from the left end to the right end of the uppermost row, and next, scanned from the left end to the right end of the next row. Thereafter, in the depthmap processing, the same operation is repeated.

Therefore, conventionally, it takes time to operate the depthmap processing to the images other than the front vehicle in the photographic image 400.

The distance calculation processing execution unit 105 according to the present embodiment operates the depthmap processing exclusively to the image of the front vehicle extracted by the image extraction unit 104. Hence, the processing time can be shortened.

A three-dimensional model generation unit 106 generates a three-dimensional model by the wire frame using the distance and the like to the closest point calculated by the distance calculation processing execution unit 105.

An output unit 107 outputs the three-dimensional model generated by the three-dimensional model generation unit 106 to a HUD and the like.

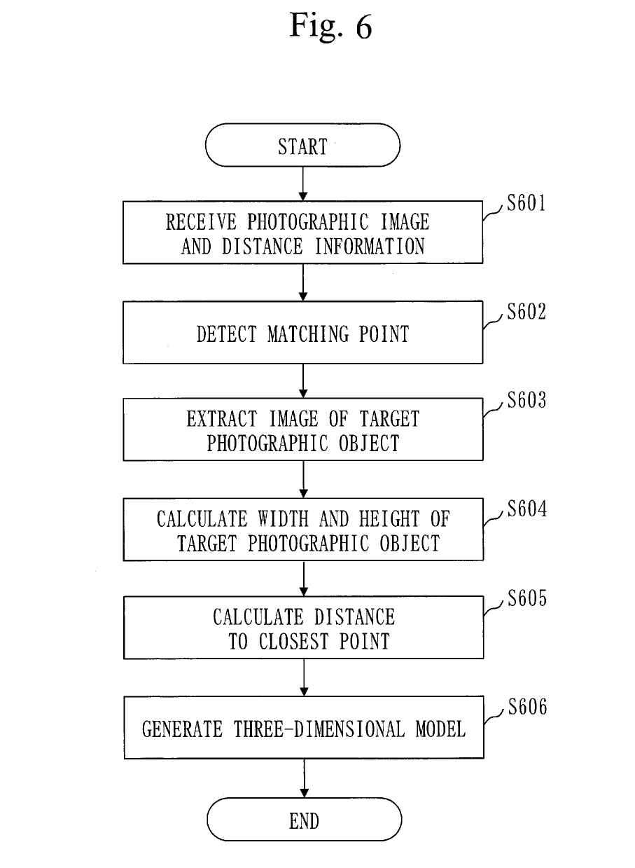

Next, an operation example of the information processing apparatus 100 according to the present embodiment will be described with reference to a flowchart of FIG. 6.

Firstly, the photographic image acquisition unit 101 acquires the photographic image 400 from the camera 200, and the distance information acquisition unit 102 acquires the distance information 500 from the sensor 300 (S601).

Next, the matching point detection unit 103 detects the matching point of the photographic image 400 and the distance information 500 (S602).

That is, the matching point detection unit 103 associates, such as FIG. 7, the photographic image 400 with the distance information 500.

Next, the image extraction unit 104 acquires the photographic image 400 and the distance information 500 associated by the matching point detection unit 103 and extracts the image of the photographic object (the front vehicle) of the creation target for the wire frame (S603).

More specifically, the image extraction unit 104 scans, as illustrated in FIG. 8, a rectangular recognition range 800 on the photographic image 400 and extracts the image of the vehicle.

In the recognition range 800, a silhouette of a rear surface of the vehicle (a shape of a dashed line of FIG. 8) is defined.

When an image suitable for the silhouette of the recognition range 800 is found by scanning the recognition range 800 on the photographic image 400, the image is extracted as the image of the vehicle.

As methods for achieving S603, there are two following methods.

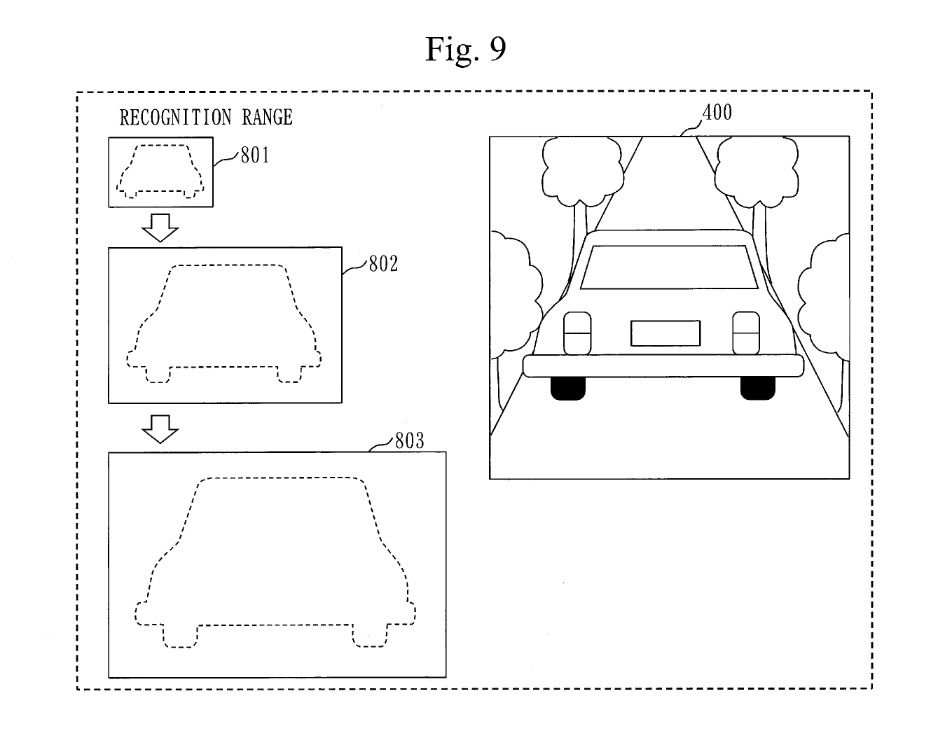

A first method is, as exemplified in FIG. 9, a method for extracting the image of the target photographic object by trial and error.

That is, when the image extraction unit 104 scans the photographic image 400 with an arbitrary sized recognition range 801, and an image suitable for the silhouette of the recognition range 801 cannot be extracted, the image extraction unit 104 scans with a larger sized recognition range 802.

In an example of FIG. 9, the image of the front vehicle in the photographic image 400 is larger compared with the silhouette of the recognition range 802. Hence, the image suitable for the silhouette of the recognition range 802 cannot be extracted.

Eventually, by a recognition range 803, the image of the front vehicle in the photographic image 400 can be extracted.

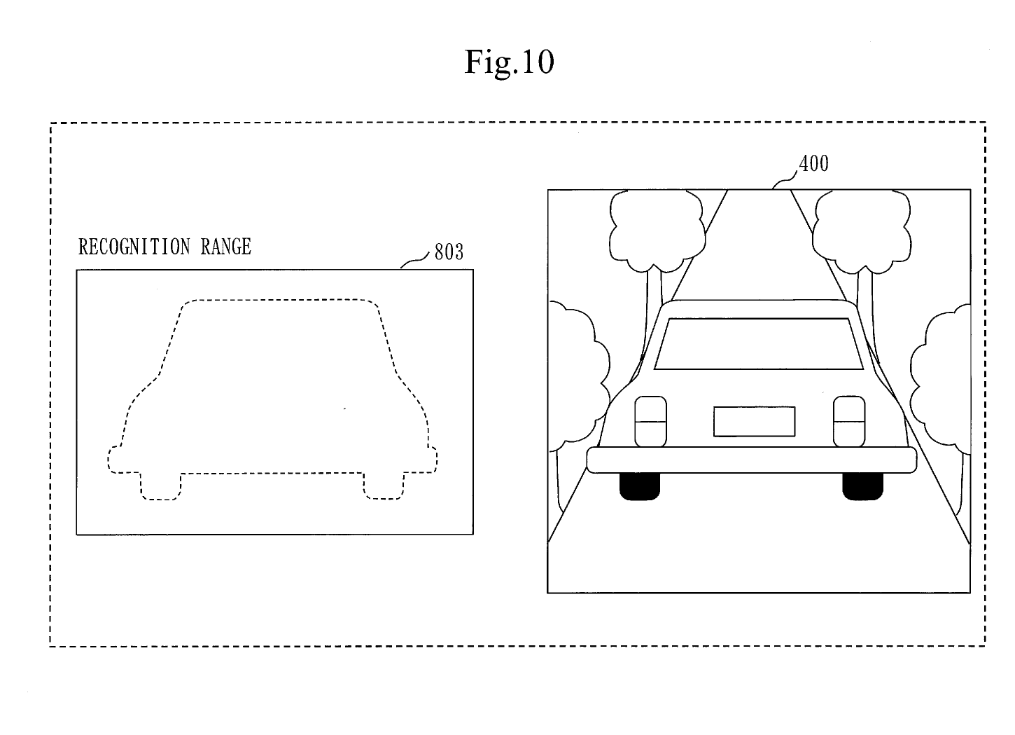

As exemplified in FIG. 10, a second method uses the distance information from the sensor 300, predicts the recognition range 803 suitable for the image of the front vehicle in the photographic image 400, scans the predicted recognition range 803 on the photographic image 400, and extracts the image of the front vehicle.

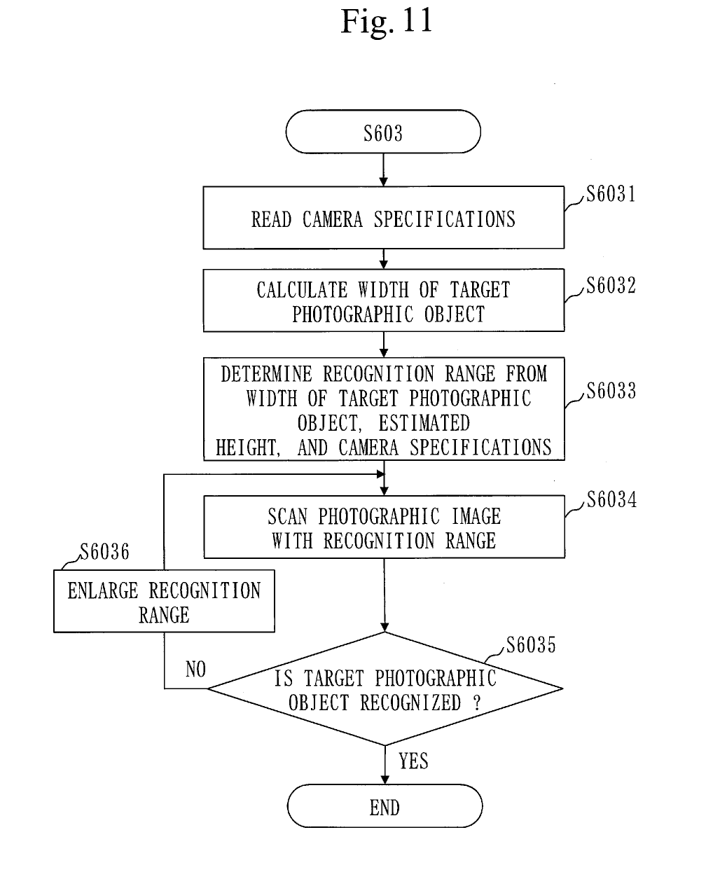

The details of this method will be described with reference to a flowchart of FIG. 11.

The image extraction unit 104 reads, firstly, the camera specifications from the camera specifications storage unit 108 (S6031).

Specifically, the image extraction unit 104 reads the presence or absence of lens distortion of the camera, a size of the photographic image, the focal length, a photographic size at the focal length, and the like.

Next, the image extraction unit 104 calculates a width of the target photographic object (the front vehicle) (S6032).

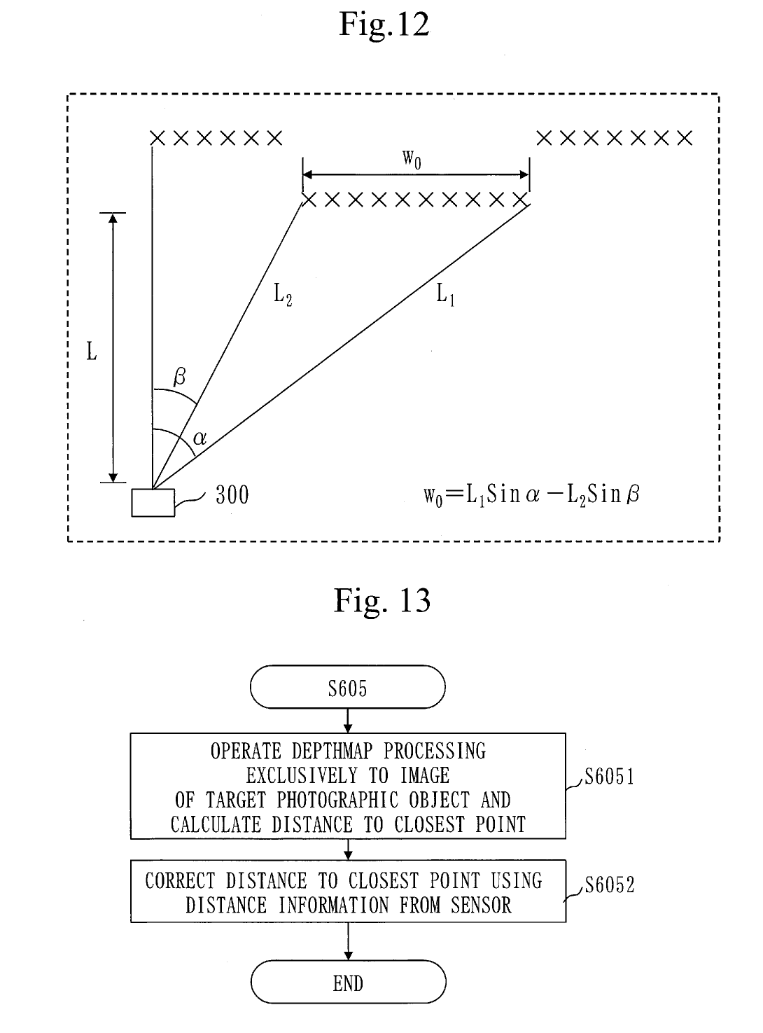

A process of S6032 will be described using FIG. 12.

FIG. 12 schematically illustrates a position relation between the sensor 300 and the bumper part of the front vehicle.

A width w₀ of FIG. 12 is an actual width of the bumper part of the vehicle and corresponds to the width of the front vehicle w₀ (the actual width) illustrated in FIGS. 5 and 7.

A distance between the right end of the width w₀ (the right end of the bumper part) and the sensor 300 of FIG. 12 is L₁, and a distance between the left end of the width w₀ (the left end of the bumper part) and the sensor 300 of FIG. 12 is L₂.

An angle α is an angle between the front direction of the sensor 300 and the direction towards the right end of the width w₀, and an angle β is an angle between the front direction of the sensor 300 and the direction towards the left end of the width w₀.

The image extraction unit 104 can obtain an actual length of the width w₀ (for example, 1.5 meters and the like) by calculating w₀=L₁ Sin α−L₂ Sin β.

Next, the image extraction unit 104 determines a size of the recognition range 803 from the width of the target photographic object (the front vehicle) obtained in S6032, an estimated height, and the camera specifications (S6033).

The estimated height is an estimated height of the vehicle, for example, 2 meters.

Here, as the camera specifications, it is assumed that: (1) a lens of the camera 200 has no distortion; (2) the size of the photographic image of the camera 200 is 640×480; (3) the focal length of the camera 200 is f; and (4) a lateral length and a longitudinal length of the photographic size at the focal length is d1 and d2.

In this case, d1/640 is a distance per pixel in the horizontal direction at the focal length f, and d2/480 is a distance per pixel in the vertical direction at the focal length f.

A width per pixel in the horizontal direction is w₁, and as illustrated in FIG. 12, a distance between the sensor 300 in the front direction (the focal length direction) of the sensor 300 and the width w₀ (the bumper part of the vehicle) is L (L=L₂ cos β).

The image extraction unit 104 calculates the width w₁ per pixel in the horizontal direction by d1/640:w₁=f:L

Further, the image extraction unit 104 also calculates a height per pixel by the same ration calculation.

Then, the image extraction unit 104 divides the width w₀ by the width w₁ per pixel, divides the estimated height: 2 meters by the height per pixel, and determines the size of the recognition range 803.

Next, the image extraction unit 104, as illustrated in FIG. 10, scans the photographic image 400 with the recognition range 803 (S6034).

When the image suitable for the recognition range 803 can be extracted, the image extraction unit 104 ends a process because the target photographic object can be recognized (YES in S6035).

On the other hand, when the image suitable for the recognition range 803 cannot be extracted, the image extraction unit 104 enlarges the recognition range (S6036) and repeats the process after S6034 because the target photographic object cannot be recognized (NO in S6035).

In S6036, for example, the recognition range is enlarged at a default enlargement rate (5% enlargement or the like).

The description is returned to the flowchart of FIG. 6.

After extracting the image of the target photographic object (S603), next, the image extraction unit 104 calculates the width and a height of the target photographic object (the front vehicle) (S604).

When a process of S603 is operated according to procedures of FIGS. 10 and 11, the image extraction unit 104 calculates only the height of the target photographic object because the width w₀ has already been calculated.

Although the estimated height: 2 meters is used in the case of the procedures of FIGS. 10 and 11, since the accurate height of the target photographic object (the front vehicle) has not been calculated, the image extraction unit 104 calculates an accurate height.

Specifically, the image extraction unit 104 counts the number of pixels in the height direction in the extracted image of the front vehicle, and the height of the front vehicle is calculated by multiplying the counted number of pixels by the height per pixel.

When the process of S603 is operated according to a procedure of FIG. 9, either the width or the height of the target photographic object (the front vehicle) has not been calculated.

Regarding the width, the image extraction unit 104 calculates a length of width by the above calculation method of the width w₀ (w₀=L₁ Sin α−L₂ Sin β).

Regarding the height, the image extraction unit 104 calculates the height per pixel by the method indicated in the description of S6033 in FIG. 11, counts the number of pixels in the height direction in the extracted image of the front vehicle, and the height of the front vehicle is calculated by multiplying the counted number of pixels by the height per pixel.

Next, the distance calculation processing execution unit 105 calculates the distance to the closest point within the target photographic object (the front vehicle) (S605).

The details of a process of S605 are indicated in FIG. 13.

The distance calculation processing execution unit 105 acquires from the image extraction unit 104 the image of the target photographic object (the front vehicle) extracted by the image extraction unit 104, operates the depthmap processing exclusively to the image of the target photographic object (the front vehicle), and calculates the distance from the camera 200 to the closest point within the target photographic object (the front vehicle) (S6051)

Next, the distance calculation processing execution unit 105 corrects the distance to the closest point calculated in S6051 using the distance information from the sensor 300 (S6052).

Normally, the depthmap processing cannot calculate a distance with high accuracy. Hence, here, the distance to the closest point is obtained with high accuracy by the correction of S6052.

Note that depending on required accuracy, a process of S6052 may be omitted.

As described, the width and the height of the target photographic object (the front vehicle) are identified by S604, and the distance (the distance to the closest point) to the target photographic object (the front vehicle) is identified by S605.

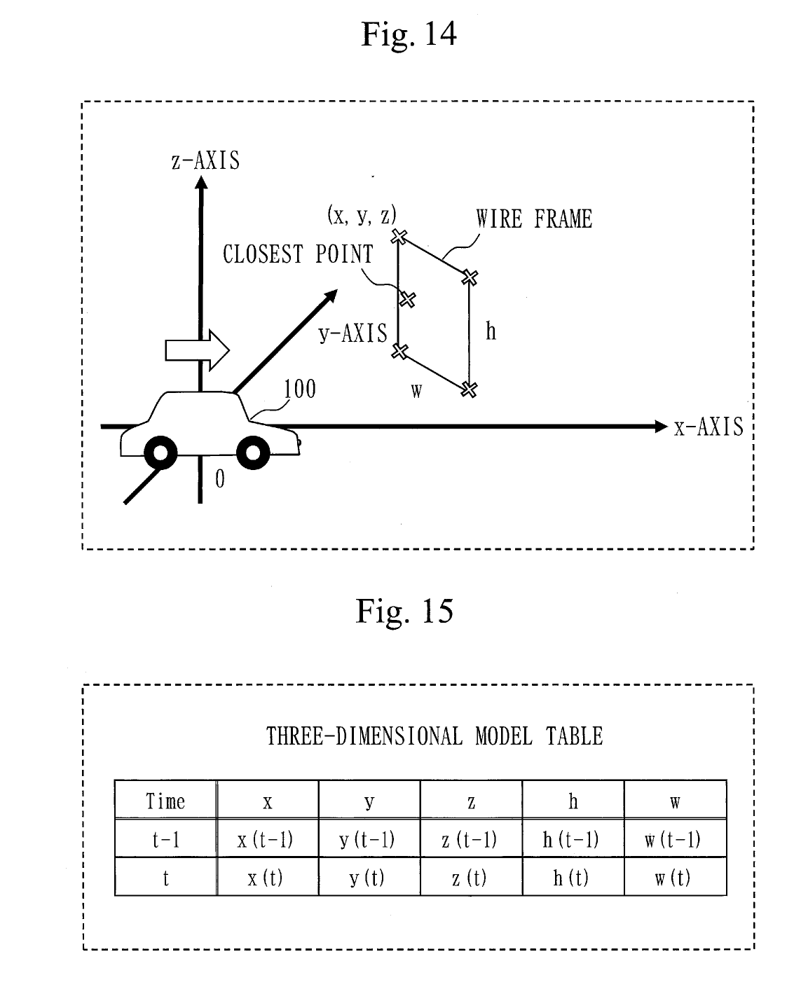

The three-dimensional model generation unit 106 acquires from the image extraction unit 104 the width and the height of the target photographic object (the front vehicle), acquires from the distance calculation processing execution unit 105 the distance (the distance to the closest point) to the target photographic object (the front vehicle), and generates the three-dimensional model using the wire frame such as FIG. 14.

In FIG. 14, x, y, and z respectively indicate a distance on the x-axis, a distance on the y-axis and a distance on the z-axis to the closest point from the camera 200, and w and h respectively indicate the width and the height of the target photographic object (the front vehicle).

The three-dimensional model generation unit 106 holds, for example, the three-dimensional model as a table such as FIG. 15.

x(t−1), y(t−1), z(t−1), h(t−1), and w(t−1) of FIG. 15 are values of x, y, z, h, and w calculated from a photographic image at a time t−1.

x(t), y(t), z(t), h(t), and w(t) of FIG. 15 are values of x, y, z, h, and w calculated from a photographic image at a time t.

As described, the three-dimensional model generation unit 106 generates the three-dimensional model by the wire frame model in real time from the acquired photographic image.

As described above, the information processing apparatus 100 according to the present embodiment acquires, by utilizing information from the camera 200 and the sensor 300 mounted on the vehicle, the distance (x, y, z) to the closest point of the target photographic object which is an obstacle and a square (w, h) which indicates a size of the photographic object.

Then, the information processing apparatus 100 according to the present embodiment expresses the target photographic object with the closest point and the wire frame.

As described, the information processing apparatus 100 according to the present embodiment expresses the target photographic object with the closest point and the wire frame. Hence, an effect that a calculation amount is smaller than those by a solid model and a surface model is obtained.

Further, the information processing apparatus 100 according to the present embodiment operates the distance calculation processing exclusively to the image of the target photographic object. Hence, time to calculate the distance to the closest point can be shortened.

Further, the information processing apparatus 100 according to the present embodiment can shorten time to extract the image of the target photographic object by operating the extraction process of the image of the target photographic object using the procedures of FIGS. 10 and 11.

### Embodiment 2

In the above first embodiment, although the square surrounding the object is expressed with the wire frame, it may be expressed with the closest point and an ID (Identifier) of the target photographic object if the size of the object is not necessary to be expressed.

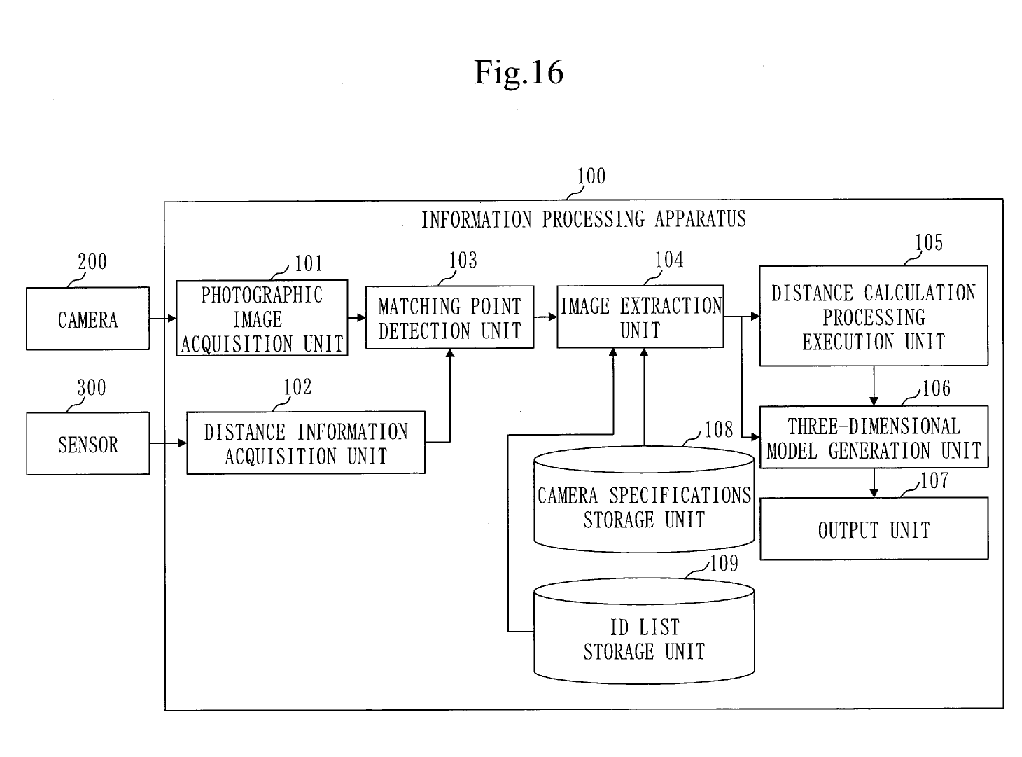

FIG. 16 illustrates a configuration example of the information processing apparatus 100 according to the present embodiment.

In FIG. 16, compared with the configuration of FIG. 1, an ID list storage unit 109 is added.

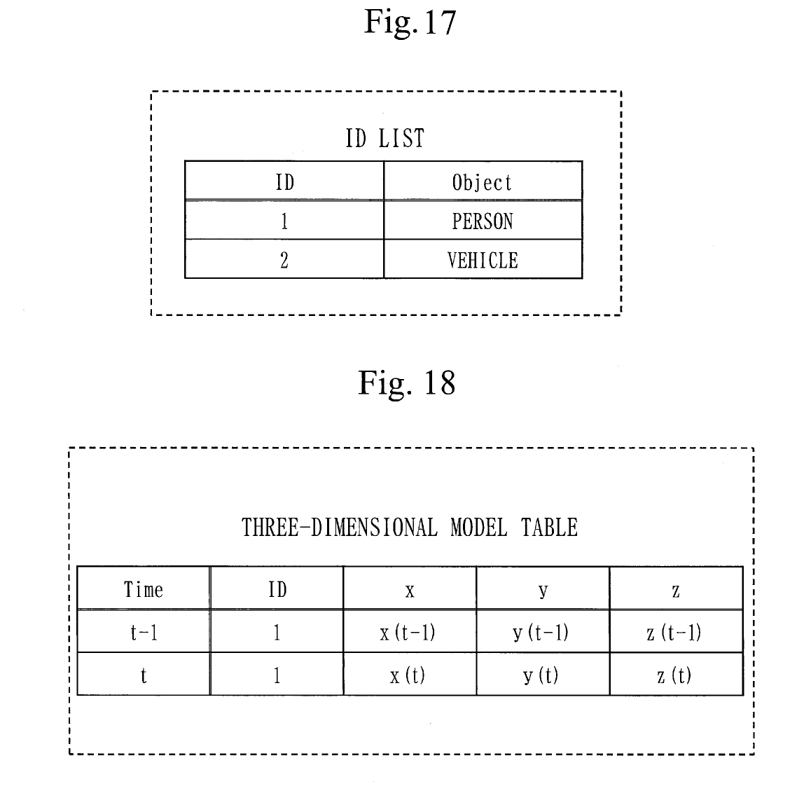

The ID list storage unit 109 stores an ID list exemplified in FIG. 17.

In the ID list, the ID of each object (a person or a vehicle in an example of FIG. 17) is described.

The ID described in the ID list is an example of a photographic object category ID.

Differences from the first embodiment are as follows.

Except for the following points, the same operation as the first embodiment is operated in the present embodiment.

In the present embodiment, the image extraction unit 104 retrieves the ID of the target photographic object from the ID list of the ID list storage unit 109 and notifies the three-dimensional model generation unit 106 of the ID of the target photographic object.

When the image extraction unit 104 extracts, for example, the image of the vehicle from the photographic image 400 as the image of the target photographic object, based upon the ID list of FIG. 17, ID:2 is notified to the three-dimensional model generation unit 106.

The image extraction unit 104 functions as an ID notifying unit in the present embodiment.

The three-dimensional model generation unit 106 generates, based upon the distance to the closest point notified from the distance calculation processing execution unit 105 and the ID notified from the image extraction unit 104, the three-dimensional model consisting of the distance to the closest point and the ID.

The three-dimensional model generation unit 106 holds, for example, the three-dimensional model as a table such as FIG. 18.

While values of h and w are managed in the table of FIG. 15, the ID is managed instead of the values of h and w in the table of FIG. 18.

As described above, in the present embodiment, the size of the object is prevented from being expressed with the wire frame. Hence, an effect that a calculation amount is further reduced is obtained.

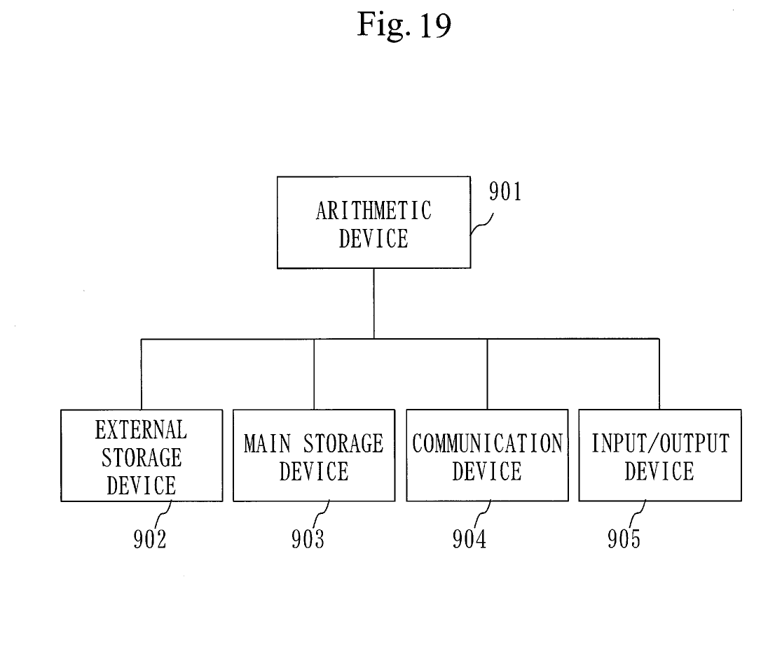

Lastly, a hardware configuration example of the information processing apparatus 100 indicated in the first and second embodiments will be described with reference to FIG. 19.

The information processing apparatus 100 is a computer, and each component of the information processing apparatus 100 can be implemented by a program.

As the hardware configuration of the information processing apparatus 100, an arithmetic device 901, an external storage device 902, a main storage device 903, a communication device 904, and an input/output device 905 are connected to a bus.

The arithmetic device 901 is a CPU (Central Processing Unit) that executes programs.

The external storage device 902 is, for example, a ROM (Read Only Memory), a flash memory, or a hard disk device.

The main storage device 903 is a RAM (Random Access Memory).

The camera specifications storage unit 108 and the ID list storage unit 109 are implemented by the external storage device 902 or the main storage device 903.

The communication device 904 is, for example, a NIC (Network Interface Card).

The input/output device 905 is, for example, a key, a button, etc., or a display, etc.

The programs are usually stored in the external storage device 902 and are loaded into the main storage device 903 to be sequentially read and executed by the arithmetic device 901.

The programs are those which implement functions each described as “unit” (the camera specifications storage unit 108 and the ID list storage unit 109 excluded; the same also applies hereinafter) illustrated in FIGS. 1 and 16.

Further, the external storage device 902 also stores an operating system (OS), and at least a part of the OS is loaded into the main storage device 903. The arithmetic device 901 executes the programs each of which implements the function of “unit” illustrated in FIGS. 1 and 16, while executing the OS.

Further, in the description of the first and second embodiments, information, data, signal values, and variable values indicating the results of the processes described as “judge”, “determine”, “extract”, “detect”, “scan”, “calculate”, “correct”, “generate”, “acquire”, “output”, and the like are stored as files in the main storage device 903.

Further, the photographic image acquired from the camera 200 and the distance information acquired from the sensor 300 are stored in the main storage device 903.

Note that the configuration of FIG. 19 merely indicates a hardware configuration example of the information processing apparatus 100, and the hardware configuration of the information processing apparatus 100 is not limited to the configuration illustrated in FIG. 19, but can be another configuration.

Further, by procedures indicated in the first and second embodiments, the information processing method according to the present invention can be implemented.

### REFERENCE SIGNS LIST

100: information processing apparatus, 101: photographic image acquisition unit, 102: distance information acquisition unit, 103: matching point detection unit, 104: image extraction unit, 105: distance calculation processing execution unit, 106: three-dimensional model generation unit, 107: output unit, 108: camera specifications storage unit, 109: ID list storage unit, 200: camera, and 300: sensor.

1-12. (canceled)

13. An information processing apparatus comprising:
processing circuitry to:
calculate a width of a specific photographic object from among photographic objects included in a photographic image photographed by a camera using a ranging result of a sensor which operates ranging in a photographing direction of the camera, in parallel with photographing by the camera, estimate an image size of an image of the specific photographic object in the photographic image based upon the calculated width of the specific photographic object, and extract the image of the specific photographic object from the photographic image by operating an image recognition within the photographic image with the estimated image size of the specific photographic object; and
execute a distance calculation processing in which a distance from the camera to a photographic object is calculated using an image of the photographic object included in the photographic image, exclusively to the image of the specific photographic object extracted.

14. The information processing apparatus according to claim 13,
wherein the processing circuitry, when the image of the specific photographic object cannot be extracted as a result of operating the image recognition within the photographic image with the image size, operates the image recognition within the photographic image with an image size being larger than the image size and extracts the image of the specific photographic object.

15. The information processing apparatus according to claim 13,
wherein the processing circuitry executes the distance calculation processing exclusively to the image of the specific photographic object and calculates the distance from the camera to a closest point which is closest to the camera within the specific photographic object, and
further generates a three-dimensional model of the specific photographic object by a wire frame using the distance from the camera to the closest point calculated.

16. The information processing apparatus according to claim 15,
wherein the processing circuitry analyzes the image of the specific photographic object extracted and calculates a height of the specific photographic object, and
generates the three-dimensional model of the specific photographic object by the wire frame using the distance from the camera to the closest point calculated, the width of the specific photographic object calculated, and the height of the specific photographic object calculated.

17. The information processing apparatus according to claim 15,
wherein the processing circuitry further generates the three-dimensional model of the specific photographic object by the wire frame using the distance from the camera to the closest point calculated and a photographic object category ID (Identifier) which represents a category of the specific photographic object.

18. The information processing apparatus according to claim 13,
wherein the processing circuitry executes a depthmap processing as the distance calculation processing.

19. The information processing apparatus according to claim 13,
wherein the processing circuitry, as the distance calculation processing, executes the depthmap processing and a correction processing in which a result of the depthmap processing is corrected using the ranging result of the sensor which operates ranging in the photographing direction of the camera, in parallel with photographing by the camera.

20. The information processing apparatus according to claim 13,
wherein the processing circuitry extracts the image of the specific photographic object from the photographic image of the photographic object photographed by the camera mounted on a mobile body, the photographic object being located outside of the mobile body.

21. An information processing method comprising:
calculating a width of a specific photographic object from among photographic objects included in a photographic image photographed by a camera using a ranging result of a sensor which operates ranging in a photographing direction of the camera, in parallel with photographing by the camera, estimating an image size of an image of the specific photographic object in the photographic image based upon the calculated width of the specific photographic object, and extracting the image of the specific photographic object from the photographic image by operating an image recognition within the photographic image with the estimated image size of the specific photographic object; and
executing a distance calculation processing in which a distance from the camera to a photographic object is calculated using an image of the photographic object included in the photographic image, exclusively to the image of the extracted specific photographic object.

22. A non-transitory computer readable medium storing a program to cause a computer to:
calculate a width of a specific photographic object from among photographic objects included in a photographic image photographed by a camera using a ranging result of a sensor which operates ranging in a photographing direction of the camera, in parallel with photographing by the camera, estimate an image size of an image of the specific photographic object in the photographic image based upon the calculated width of the specific photographic object, and extract the image of the specific photographic object from the photographic image by operating an image recognition within the photographic image with the estimated image size of the specific photographic object; and
execute a distance calculation processing in which a distance from the camera to a photographic object is calculated using an image of the photographic object included in the photographic image, exclusively to the image of the extracted specific photographic object.
